(19) United States
(12) Patent Application Publication
(10) Pub. No.: US 2004/0016250 A1
(43) Pub. Date: Jan. 29, 2004

(54) Vehicle air-conditioning system

(76) Inventors: Nobuya Nakagawa, Nishi-Kasugai-gun (JP); Toshihisa Kondo, Nishi-kasugai-gun (JP); Kazuo Ishii, Nishi-kasugai-gun (JP); Tuyoshi Ohminami, Nishi-kasugai-gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/409,167

(22) Filed: Apr. 9, 2003

Related U.S. Application Data
(63) Continuation of application No. PCT/JP02/07451, filed on Jul. 23, 2002.

(30) Foreign Application Priority Data
Jul. 24, 2001 (JP) 2001-222865

(51) Int. Cl. F25D 17/04; B60H 1/00

(52) U.S. Cl. 62/186; 165/202

(57) ABSTRACT

A vehicle air-conditioning system (1) according to the present invention has an evaporator (4), a heater core (6), a temperature controlling damper (20) for controlling the amounts of air passed and not passed through the heater core, a plurality of discharge outlets (22, 24, 26), a mode setting means (36) for manually selecting and setting a specific mode, a mode setting means (36) for manually setting a desired temperature, and a characteristic setting means for previously setting a predetermined relationship (shown by a line A in FIG. 4) between the temperature setting means and the damper opening of the temperature controlling damper by using a program such that the relationship between the temperature set by the temperature setting means and the air temperature at the discharge outlets has a predetermined characteristic (shown by a line C in FIG. 4), in the specific mode set by said mode setting means.

### FIELD OF THE INVENTION

The present invention relates to an air-conditioning system for vehicles and more particularly to a vehicle air-conditioning system of the manual type having a plurality of modes.

### BACKGROUND ART

In recent years, there has been developed a vehicle air-conditioning system which comprises an evaporator functioning as a cooling heat-exchanger and a heater core functioning as a heating heat-exchanger as a unit, thereby providing an improved space availability in the area of a passenger compartment, more particularly, increasing a foot-receiving space, and also reducing the manufacturing cost.

Several examples of such a vehicle air-conditioning system are disclosed by Japanese Laid Open Patent Application Nos. 250344/1998 and 250345/1998.

In the vehicle air-conditioning systems disclosed in these Japanese patent applications, a heater core is located behind an evaporator. A temperature controlling damper is located between the evaporator and the heater core to provide a desired air temperature by controlling the amounts of air passing through the heater core and not passing the heater core after the air has passed through the evaporator. Thus, the conditioned air will be discharged from outlets which are provided at various desired vehicle locations.

In a manual type vehicle air-conditioning system according to the prior art, a driver selects a desired mode from a plurality of modes and sets a desired temperature using a temperature controlling lever (or temperature controlling dial) which forms a temperature setting means. Mode and temperature controlling dampers are positioned according to such selection and setting of the mode and temperature to discharge the conditioned air through the outlets.

At this time, it is desirable that the relationship between the temperature set by the driver and the temperature of the air discharged from the outlets is generally linear (or linearly proportional). However, the manual type vehicle air-conditioning system of the prior art did not provide such a linear relationship between both the temperatures.

This will be described with reference to FIG. 1. FIG. 1 shows the relationship between the position of a temperature controlling lever and the damper opening position of a temperature controlling damper (FIG. 1(a)); the relationship between the damper opening and the temperature of air at a discharge outlet (or discharge temperature) (FIG. 1(b)) and the relationship between the position of the temperature controlling lever and the discharge temperature (FIG. 1(c)), in a vehicle air-conditioning system according to the prior art.

In the prior art, the relationship between the position of the temperature controlling lever position and the damper opening was set to be linear (or linear proportional) as shown by a line a in FIG. 1(a). At this time, as shown in FIG. 1(b), the relationship between the damper opening and the discharge temperature would not be linear (line b), but had such a relationship as represented by a line c. That is to say, the discharge temperature was abruptly increased even if the damper was slightly opened. As a result, as shown in FIG. 1(c), the relationship between the temperature controlling lever and the discharge temperature would not be linear (line b), but had such a relationship as represented by a line e. For such a reason, the prior art was disadvantageous in that even if the temperature controlling lever was set on a slightly higher temperature side, the discharge temperature was lowered more than the desired temperature or raised more than the desired temperature.

To overcome such a problem, the prior art has interposed a special cam mechanism for providing the desired relationship between the temperature controlling lever position and the discharge temperature, that is, a linear relationship (shown by a line d) between the temperature controlling damper and a motor driving this damper. If it is purposed that each of the modes has its different characteristic (or the relationship between the temperature controlling lever position and the discharge temperature), a new and separate damper was provided which functions to change the proportion of the air passed through the heater core to the air not passed through the heater core, thereby providing the desired characteristic through such a cam mechanism at each of the mode.

However, provision of the special cam mechanism and/or new damper makes the structure of the air-conditioning system complicated. This is also subjected to the spacial restriction and increases the manufacturing cost.

### DISCLOSURE OF THE INVENTION

It is therefore an object of the present invention to provide a vehicle air-conditioning system which can relatively simply and easily provide the desired characteristic between the temperature manually set by a temperature setting mean and the temperature of the conditioned air discharged through the discharge outlets.

Another object of the present invention is to provide a vehicle air-conditioning system which can simply and easily provide the desired characteristic between the manually set temperature and the temperature of the conditioned air from the discharge outlets in a plurality of modes.

In order to achieve the objects, the present invention provides a manual type vehicle air-conditioning system having a plurality of modes, said system comprising an evaporator, a heater core disposed rearward of this evaporator, a temperature controlling damper for controlling the amounts of air not passed through the heater core and passed through the heater core after the air has passed through the evaporator, a mode damper for selecting one or more of a plurality of discharge outlets so arranged that an air conditioned by the evaporator and heater core is discharged therethrough in place, said one or more discharge outlets being selected corresponding to one of the respective modes, a mode setting means for manually setting a specific mode from said plurality of modes, a temperature setting means for manually setting a desired temperature, and a characteristic setting means for previously setting a predetermined relationship between the temperature setting means and the damper opening of the temperature controlling damper by using a program such that the relationship between the temperature set by the temperature setting means and the air temperature at the discharge outlets has a predetermined characteristic in the specific mode set by the mode setting means.

Since such an arrangement according to the present invention has previously set a predetermined relationship between the temperature setting means and the damper opening of the temperature controlling damper by using a program such that the characteristic setting means provides a predetermined characteristic to the relationship between the temperature set by the temperature setting means and the air temperature at the discharge outlets in the specific mode, the present invention can eliminate any particular cam mechanism and/or damper which would be required in the prior art and thus set and change the characteristic in an extremely simple and easy manner.

In the present invention, the predetermined characteristic provided to the relationship between the temperature set by the characteristic setting means and the air temperature at the discharge outlets is preferably linear.

In the present invention, the program in the characteristic setting means preferably includes a map in which any one of various different relationships between the temperature setting means and the damper opening of the temperature controlling damper can have been set.

In the present invention, the map included in the program of the characteristic setting means preferably sets such that the rate of change in the damper opening relative to change of the temperature is smaller when the damper opening is smaller or larger, rather than when the damper opening is middle.

In the present invention, the characteristic setting means preferably sets the relationship between the temperature setting means and the damper opening of the temperature controlling damper such that at least two modes have different characteristics.

### BRIEF DESCRIPTION OF DRAWINGS

FIG. 1 is a diagram illustrating the characteristic of a conventional vehicle air-conditioning system.

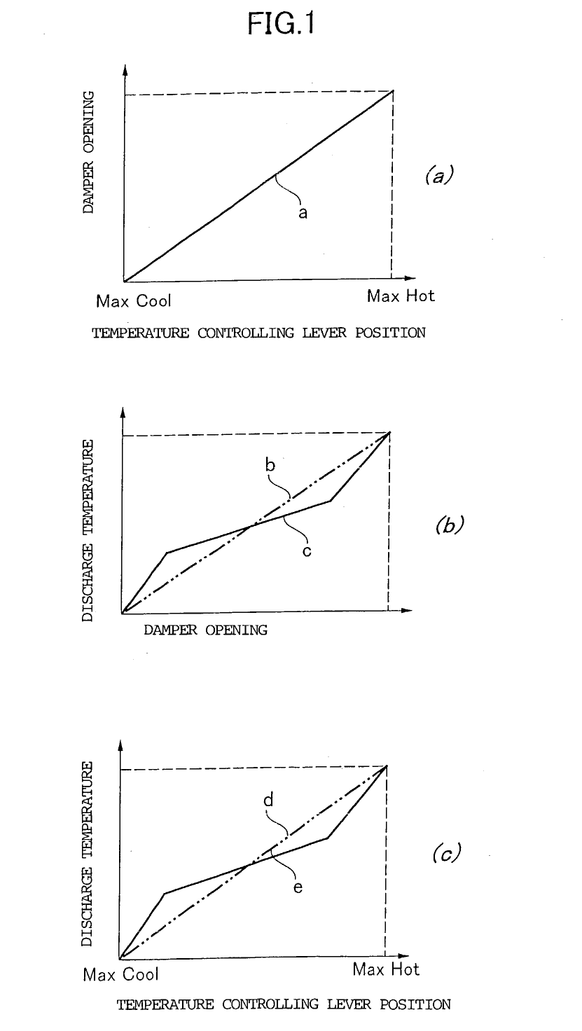

FIG. 2 is a longitudinal cross-section illustrating the basic configuration of a vehicle air-conditioning system according to one embodiment of the present invention.

FIG. 3 is a view illustrating a control panel in a vehicle air-conditioning system according to one embodiment of the present invention.

FIG. 4 is a diagram illustrating the characteristic of a vehicle air-conditioning system according to one embodiment of the present invention.

### BEST MODE FOR CARRYING OUT THE INVENTION

One embodiment of the present invention will now be described with reference to the accompanying drawings.

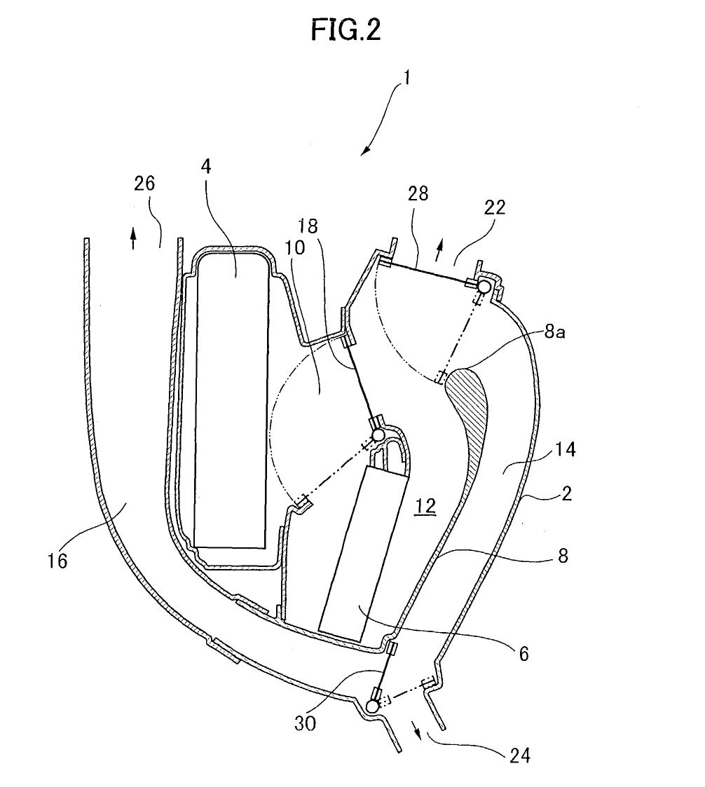

First of all, the basic configuration of a vehicle air-conditioning system 1 according to one embodiment of the present invention will be described with reference to FIG. 2.

The vehicle air-conditioning system 1 comprises a casing 2 in which a substantially upright evaporator 4 functioning as a cooling heat exchanger and a heater core 6 functioning as a heating heat exchanger disposed below the downstream side of this evaporator 4 are mounted.

The air-conditioning system 1 also comprises a partition plate disposed downstream of the heater core 6. This partition plate 8 has its top end 8a in the form of streamline.

This vehicle air-conditioning system 1 further comprises a bypass passageway 10 formed downstream of the evaporator 4 for bypassing the heater core 6, a heater passageway 12 formed between the heater core 6 and the partition plate 8 downstream of the heater core 6, a foot passage 14 formed between the partition plate 8 and the casing 2, and a defrost passage 16 formed to extend forward and upward from the bottom end of this foot passage 14. Furthermore, a mixing area 18 for mixing cool and hot airs is formed at the junction between the downstream side of the bypass passage 10 and the top side of the heater passage 12.

A temperature controlling damper 20 is further located in the bypass passage 10 downstream of the evaporator 4. This temperature controlling damper 20 functions to control the amounts of air passed and not passed through the heater core 6 in the air passed through the evaporator 4. This temperature controlling damper 20 can be set at any one of openings between full close (0%) and full open (100%). In FIG. 2, a solid line indicates the damper 20 in its 100% open position while a chain line represents the damper 20 in its 0% open position. The opening of this temperature controlling damper 20 can be regulated a drive motor (not shown).

The casing 2 further includes a vent outlet 22 formed in the rearward top of the casing 2, a foot outlet 24 formed in the rearward bottom of the casing 2, that is, on the bottom end of the foot passage 14 and a defrost outlet 26 formed in the forward top of the casing 2. The vent outlet 22 is provided with a vent damper 28 while the foot outlet 24 is provided with a foot damper 30. It is to be understood that the foot damper 28 can also function as a defrost damper since the foot damper 28 is positioned between the downstream end of the foot passage 14 and the upstream end of the defrost passage 16, thereby eliminating need of any separate defrost damper.

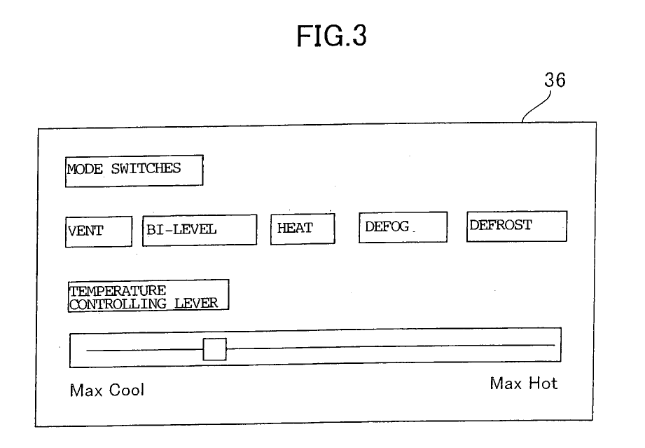

FIG. 3 illustrates a control panel for an air-conditioning system mounted on an instrument panel. This control panel 36 includes five mode switches as mode selection switches which form a mode setting means, that is, a vent mode switch “vent”, a bi-level mode switch “bi-level”, a heat mode switch “heat”, a defog mode switch “defog” and a defrost mode switch “defrost”. A driver can manually select any specific mode from these modes.

The control panel 36 also includes a temperature controlling lever which forms a temperature setting means for setting any temperature in the range between the maximum cooling temperature (MaxCool) and the maximum heating temperature (MaxHot). In such a manner, the driver can manually set any desired temperature by use of this temperature controlling lever.

The vent mode is one in which only the vent outlet 22 is opened and the temperature controlling damper 20 is positioned at a predetermined opening such that air is discharged through the vent outlet 22 at the desired temperature; the bi-level mode is one in which the vent outlet 22 is half opened, the foot outlet 24 is placed in its full open state (in which the foot damper 30 is positioned in a solid line position of FIG. 2) and the temperature controlling damper 20 is positioned at a predetermined opening position, thereby discharging air through the vent and foot outlets 22, 24 at the desired temperature, that is, in a so-called head-cool-and-foot-warm state; the heat mode is one in which only the foot outlet 24 is opened to discharge warm air through the foot outlet 24 at a predetermined temperature; the defog mode is one in which the vent outlet 22 is closed, the foot damper 30 is half opened and the temperature controlling damper 20 is positioned at a predetermined opening state, thereby discharging warm air through the foot and defrost outlets 24, 26 at the desired temperature. Furthermore, the defrost mode is one in which both the vent and foot outlets 22, 24 are closed, that is, the foot damper 30 is fully closed (at a position shown by chain line in FIG. 2), thereby discharging warm air through the defrost outlet 26 at the desired temperature.

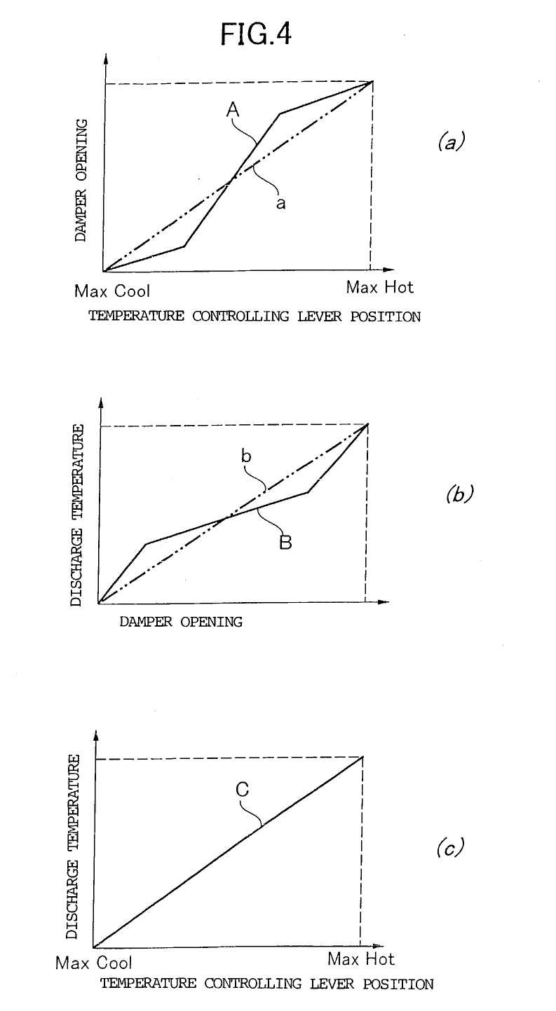

Next, the characteristic setting means in the vehicle air-conditioning system 1 according to this embodiment will be described with reference to FIG. 4. As described, the prior art used a specific cam mechanism and/or additional damper to provide a linear relationship between the temperature controlling lever position and the discharge temperature.

In this embodiment, however, the relationship between the temperature controlling lever position and the damper opening is first set to have a characteristic as shown by a line A in FIG. 4(a). This line A has previously been stored in a damper drive/control program as a map. The map of this damper drive/control program is designed to decrease the rate of change in the damper opening relative to change of the temperature when the damper opening is smaller or larger, rather than when the damper opening is middle, as shown in FIG. 4(a). This damper drive/control program also controls the opening of the temperature controlling damper 20 using the characteristic represented by the mapped line A. Thus, the discharge temperature can be prevented from being abruptly increase even if the damper is slightly opened.

When the damper opening is determined by the temperature controlling lever position based on the characteristic of this line A, it can determine the discharge temperature, as shown in FIG. 4(b). The relationship between this damper opening and the discharge temperature is as shown by a line B.

As a result, the relationship between the temperature controlling lever position and the discharge temperature is linear (or linearly proportional) as shown by a line C in FIG. 4(c). Therefore, the relationship between the temperature controlling lever position and the discharge temperature can provide the desired characteristic.

In such a manner, this embodiment has previously stored a plurality of preset relationships between the temperature controlling lever position and the damper opening as a map to provide a desired characteristic (or linear relationship) between the temperature controlling lever position and the discharge temperature, with such a map being used to control the damper opening through a program for controlling the damper motor.

Therefore, this embodiment can simply and easily change the desired characteristic between the temperature controlling lever position and the discharge temperature for each of the modes.

The desired characteristic between the temperature controlling lever position and the discharge temperature may be any characteristic other than the linear relationship. At this time, it is also necessary to change the relationship between the temperature controlling lever position and the damper opening for the other characteristics.

This embodiment can extremely simply and easily set and change the characteristics since the characteristic between the temperature controlling lever position and the discharge temperature can be changed in the software manner or through the program, rather than the hardware manner as in the prior art.

What is claimed is:

1. A manual type vehicle air-conditioning system having a plurality of modes, comprising:
an evaporator;
a heater core disposed rearward of the evaporator;
a temperature controlling damper for controlling the amounts of air passed and not passed through the heater core after the air has passed through the evaporator;
a plurality of discharge outlets positioned to discharge air conditioned by said evaporator and heat core therethrough at predetermined locations;
a mode setting means for manually selecting and setting a specific mode among said plurality of modes;
a temperature setting means for manually setting a desired temperature; and
a characteristic setting means for previously setting a predetermined relationship between said temperature setting means and the damper opening of said temperature controlling damper by using a program such that the relationship between the temperature set by the temperature setting means and the air temperature at the discharge outlets has a predetermined characteristic in the specific mode set by said mode setting means.

2. The vehicle air-conditioning system as claimed in claim 1 wherein the predetermined characteristic provided to the relationship between the temperature set by the characteristic setting means and the air temperature at the discharge outlets is linear.

3. The vehicle air-conditioning system as claimed in claim 1 wherein said program in said characteristic setting means includes a map in which the pre-selected relationships between said temperature setting means and the damper opening of said temperature controlling damper have been set.

4. The vehicle air-conditioning system as claimed in claim 3 wherein the map included in the program of said characteristic setting means sets such that the rate of change in the damper opening relative to change of the temperature is smaller when the damper opening is smaller or larger, rather than when the damper opening is middle.

5. The vehicle air-conditioning system as claimed in claim 1 wherein said characteristic setting means sets the relationship between the temperature setting means and the damper opening of the temperature controlling damper such that at least two modes have different characteristics.
